(19) United States
(12) Patent Application Publication
(10) Pub. No.: US 2010/0241561 A1
(43) Pub. Date: Sep. 23, 2010

(54) LIFE-STAGE INSURANCE

(75) Inventors: William F. Borowski, Millbury, MA (US); William J. Aheron, Charlotte, NC (US); Judith M. Anderson, East Walpole, MA (US); Kazi M. Ariff, Quincy, MA (US); Jeffrey H. Bierer, Charlotte, NC (US); Steven K. Hayes, Bemus Point, NY (US); Shane A. Johnson, Charlotte, NC (US); Jeffrey P. Judd, Boston, MA (US); Thomas D. Kelley, Hingham, MA (US); James P. Kirkman, Acton, MA (US); Yicong Li, Lexington, MA (US); Sean M. O'Connor, Scituate, MA (US); Carol A. Smith, Edgartown, MA (US); Susan S. Thomas, Gastonia, NC (US); Russell W. Tipper, Boston, MA (US); Neal G. Wolfson, Lexington, MA (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: BANK OF AMERICA CORPORATION, CHARLOTTE, NC (US)

(21) Appl. No.: 12/407,965

(22) Filed: Mar. 20, 2009

(51) Int. Cl. G06Q 40/00

(52) U.S. Cl. 705/40

(57) ABSTRACT

A method for providing a lifestage insurance product for a customer includes receiving an insurance allocation for each of a plurality of lifestages. The plurality of lifestages includes a first lifestage and a second lifestage. Insurance coverage of a first lifestage is provided for the customer in accordance with the insurance allocation of the first lifestage. The insurance coverage from the insurance allocation for the first lifestage is shifted to the insurance allocation for the second lifestage upon determining a shift in lifestages has occurred.

### BACKGROUND

Currently, insurance products provide insurance protection to a customer for a single specific situation or coverage. However, consumers' lives are variable and the specific situations or coverages that the consumers may want to protect are also variable. Accordingly, there is a need for an insurance product that is capable of protecting the consumer based on the variability of consumers' lives.

### SUMMARY

In accordance with an aspect of the present invention, a method for providing a lifestage insurance product for a customer includes receiving an insurance allocation for each of a plurality of lifestages. The plurality of lifestages includes a plurality of lifestages, such as a first lifestage and a second lifestage. Insurance coverage of a first lifestage is provided for the customer in accordance with the insurance allocation assigned to the first lifestage. When the customer's lifestages shifts, the insurance coverage also shifts from the insurance allocation for the first lifestage to the insurance allocation for the second lifestage.

In accordance with another aspect of the present invention, a method for providing a lifestage insurance product includes receiving insurance allocation choices. The insurance allocation choices include a selection of a plurality of lifestages, a selection of insurance coverages for each lifestage, and a selection of an insurance allocation of the insurance coverages for each lifestage. In accordance with the insurance allocation choices, insurance coverage is provided for the customer's lifestage. In response to a shift in lifestages, the insurance allocation of insurance coverages for the customer's current lifestage is automatically shifted to the insurance allocation assigned to another lifestage.

In accordance with yet another aspect of the present invention, a computer program product for a lifestage insurance product for a customer includes a computer-readable medium having a computer program residing thereon. The computer program includes instructions for receiving an insurance allocation for each of a plurality of lifestages, such as a first lifestage and a second lifestage. The computer program also includes instructions for providing insurance coverage of a first lifestage in accordance with the insurance allocation of the first lifestage. The computer program further includes instructions for shifting the insurance coverage from the insurance allocation for the first lifestage to the insurance allocation for the second lifestage upon determining a shift in lifestages has occurred.

In accordance with still yet another aspect of the present invention, an apparatus for a lifestage insurance product includes a processor and a module operable on the processor. The module is configured to receive an insurance allocation for each of a plurality of lifestages. The lifestages include at least a first lifestage and a second lifestage. Insurance coverage for the first lifestage is provided in accordance with the insurance allocation assigned to the first lifestage. The insurance coverage is shifted from the insurance allocation for the first lifestage to the insurance allocation for the second lifestage upon determining a shift in lifestages has occurred.

Other aspects and features of the present invention, as defined by the claims, will become apparent to those skilled in the art upon review of the following non-limited detailed description of the invention in conjunction with the accompanying figures.

### BRIEF DESCRIPTION OF THE DRAWINGS

FIG. 1 is a flow chart of an example of lifestage insurance in accordance with an embodiment of the present invention.

FIG. 2 is a block diagram using pie charts illustrating an example of the method of FIG. 1.

FIG. 3 is a block schematic diagram of an example of a system for lifestage insurance in accordance with an embodiment of the present invention.

### DETAILED DESCRIPTION

Embodiments of the present invention are described below with reference to flowchart illustrations and/or block diagrams of methods and apparatuses (systems, computer program products, devices, etc.). It will be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanism for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions which implement the function/act specified in the flowchart and/or block diagram block(s).

The computer program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

It should be understood that terms like “bank,” “financial institution,” and just “institution” are used herein in their broadest sense. Institutions, organizations, or even individuals, that process loans are widely varied in their organization and structure. Terms like bank and financial institution are intended to encompass all such possibilities, including but not limited to, finance companies, stock brokerages, credit unions, mortgage companies, insurance companies, etc. Additionally, disclosed embodiments may suggest or illustrate the use of agencies or contractors external to the financial institution to perform some of the calculations and data repository services. These illustrations are examples only, and an institution or business can implement the entire invention on their own computer systems or even a single work station if appropriate databases are present and can be accessed.

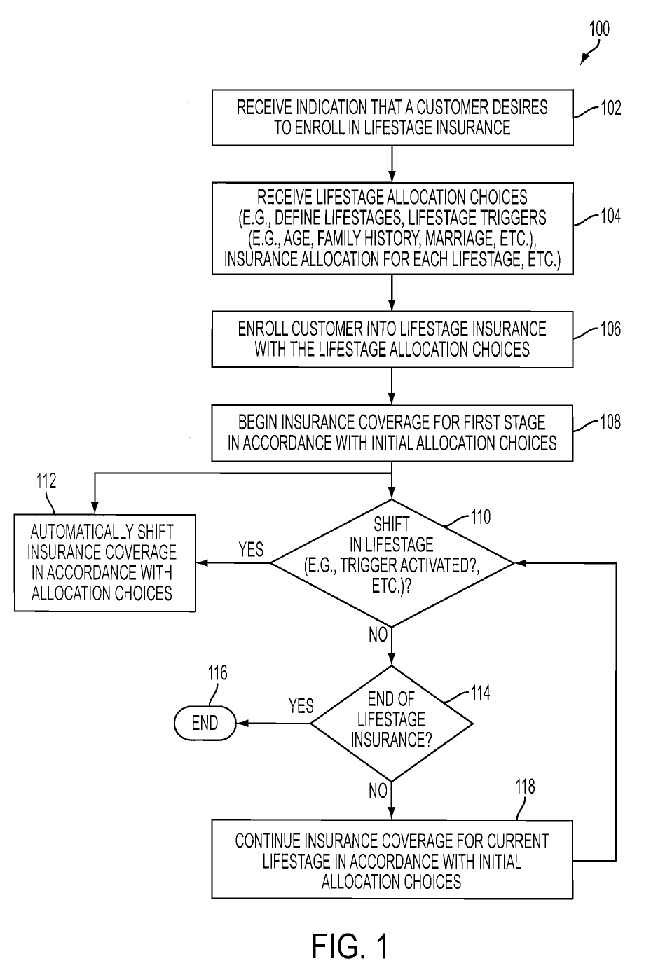

As illustrated in FIGS. 1-3, embodiments of the present invention include methods, systems and computer program products directed to lifestage insurance. In one embodiment, lifestage insurance relates to a single insurance product providing multiple insurance coverages for each of a plurality of predefined lifestages of a subscriber or customer. As is described below, the customer selects the percentages or insurance allocation of the insurance coverages for each lifestage of the customer. Accordingly, the lifestage insurance evolves and transforms its benefit structure automatically based upon the needs of the customer.

FIG. 1 is a flow chart of an example a method 100 for lifestage insurance in accordance with an embodiment of the present invention. In block 102, a customer provides an indication that the customer wants to enroll in the lifestage insurance product. This indication is received in person, over the phone, via a computer system, via an email or an online form transmitted over a network, or any other manner.

After receiving such indication to enroll in the lifestage insurance product, the lifestage insurance is customized by providing insurance allocation choices, as shown in block 104. Various insurance allocation choices allow the customer to select or define multiple lifestages, the triggers which determine shifts from one lifestage to the next, what insurance coverages the customer would like for each lifestage, and the insurance allocation or percentages of the insurance coverages for each lifestage. Other insurance allocation choices are also possible and the present invention should not be limited to the above-recited insurance allocation choices. In one embodiment, one or more insurance allocation choices are selected or defined prior to enrolling the customer in the lifestage insurance. In another embodiment, one or more insurance allocation choices are selected or defined after enrolling and providing insurance protection for the customer in the lifestage insurance.

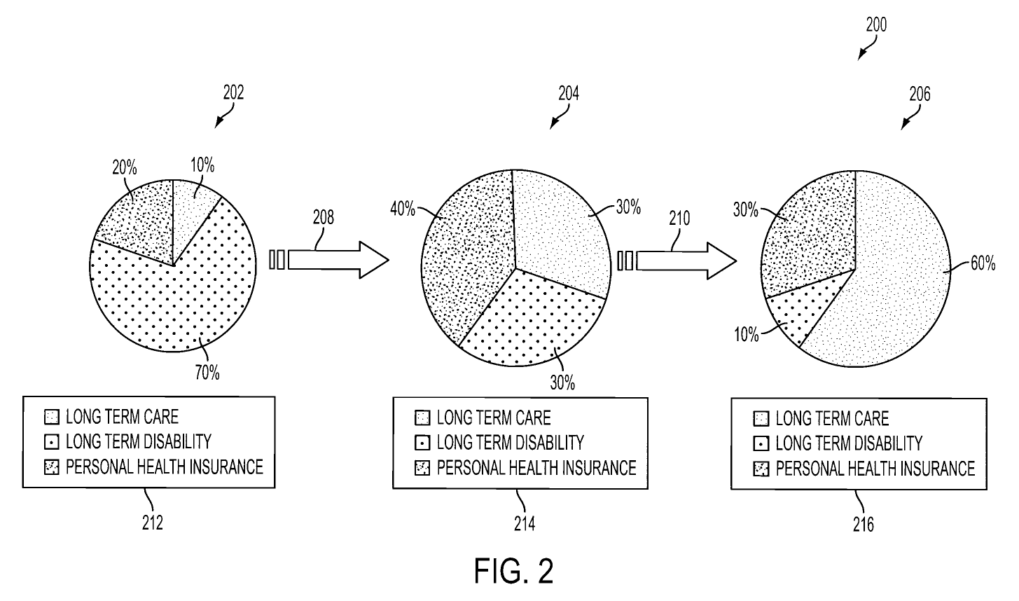

Each lifestage relates to various phases, events or aspects associated with the customer's life, such as the customer's age, health, marriage, divorce, having kids, death in the family, job loss, or any other event or aspect associated with the customer and/or the customer's family. The customer indicates what triggers will determine shifting of one lifestage to the next lifestage. For example, if the customer indicates that the lifestages will be based upon the customer's age, the customer may assign the trigger to shift the first lifestage to the second lifestage to be when the customer reaches 45 years old and the trigger to shift the second lifestage to the third lifestage to be when the customer reaches 65 years old. By way of another example, the customer may set up the lifestage insurance product such that the first lifestage continues while the customer is single and then the second lifestage occurs while the customer is married and thus, the trigger for shifting lifestages is a marriage event of the customer. It should be understood that any amount of lifestages for a single lifestage insurance product are possible as well as any number of triggers to shift lifestages. For example, FIG. 2 illustrates an implementation 200 of the method 100 having three lifestages 202, 204, 206 with two triggers 208, 210. In one embodiment, two or more triggers may be required to shift one lifestage to another lifestage.

Additionally, for each lifestage, the customer selects multiple insurance coverages, such as personal health insurance, long term care, long term disability, life insurance, dental insurance, travel insurance, and/or other insurance areas. In one embodiment, the insurance coverages may include insurance of personal property (e.g., insurance for car, boat, jewelry, antiques, art, etc.), insurance of real estate (e.g., insurance for the customer's residence, vacation house, condo, etc.), renter's insurance, and other types of insurance. Nonetheless, for each of the selected insurance coverage areas, the customer then selects the insurance allocation for each insurance coverage area by selecting the percentage that each insurance coverage has relative to the total lifestage insurance for each specific lifestage. For example, as illustrated in the first pie chart 202 of FIG. 2, the customer selects insurance allocation coverages 212, 214, 216 for each lifestage having three insurance coverage areas, including personal health insurance, long term care, and long term disability. For the first lifestage 202, the customer has selected the following insurance allocation: personal health insurance is 20% of the total insurance, long term care is 10% of the total insurance, and long term disability is the remaining 70% of the total insurance for the first lifestage. The insurance allocation is also pre-selected by the customer for the other lifestages 204, 206. For example, as illustrated in FIG. 2, the allocation for the second lifestage 204 is predefined by the customer to be: 30% for personal health insurance, 30% for long term care, and 40% for long term disability, while the allocation for the third lifestage 206 is predefined by the customer to be: 30% for personal health insurance, 60% for long term care, and 10% for long term disability. Although FIG. 2 illustrates the same insurance coverage areas 212, 214, 216 for each lifestage 202, 204, 206, it should be understood that the insurance coverage areas may be varied and do not have to be constant throughout all of the lifestages. For example, instead of having the insurance coverages of personal health insurance, long term care, and long term disability for each lifestage 202, 204, 206, the first lifestage 202 may have insurance coverages of personal health insurance, long term care, and long term disability, while the second lifestage may have insurance coverages of long term care, and life insurance and the third lifestage may have insurance coverages of personal health insurance and long term disability.

In addition to setting up the number of lifestages, the insurance coverage areas and the insurance allocation percentages for each insurance coverage area per lifestage, the customer sets up the triggers which shift one lifestage to the next lifestage. For example, in FIG. 2, the triggers (represented by arrows 208, 210) for each lifestage 202, 204, 206 are age-based such that that when the customer reaches a predefined age 208 the first lifestage 202 shifts to the second lifestage 204 and when the customer reaches a later predefined age 210 the second lifestage 204 shifts to the third lifestage 206.

Any of the insurance allocation choices, such as the triggers 208, 210, the lifestages 202, 204, 206, allocation percentages, etc., are predefined or preset by the customer prior to enrollment in the lifestage insurance. In one embodiment, any of the allocation choices are predefined or preset by the financial institution instead of the customer. In another embodiment, one or more of the allocation choices are predefined by the customer and one or more of the other allocation choices are predefined by the financial institution. In yet another embodiment, the allocation choices have default values which the customer can simply accept to enroll in the lifestage insurance product.

In block 106, after receiving the allocation choices, the financial institution enrolls the customer in the lifestage insurance product, provided the customer qualifies for the lifestage insurance product. Accordingly, in block 108, insurance coverage for the customer begins in accordance with the allocation choices for the first lifestage. During insurance coverage, the premiums that are charged to the customer as well as any payouts are based on the pro rata allocations for each insurance product. The premiums and payouts are based upon the risks associated with the insurance allocations for the current lifestage.

In block 110, a determination is made as to whether a lifestage shift has occurred. Specifically, a determination is made as to whether any of the predefined triggers or events has occurred. For example, if the customer has predefined a trigger to be when the customer reaches age 45, when this happens, the method 100 determines the trigger has occurred and thus, shifts the current lifestage to a new lifestage. If a lifestage shift, as defined by the customer, is determined to have occurred, then the method 100 proceeds to block 112; otherwise, the method 100 proceeds to block 114. In one embodiment, the triggers to shift between lifestages are received automatically by the financial institution and thus the lifestages automatically shifts without any interaction required from the customer or financial institution. In another embodiment, the customer (or other party) submits to the financial institution that one or more triggers have occurred. For example, in the event that the customer gets married, the customer notifies the financial institution of this predefined lifestage changing trigger by sending in a marriage certificate. After such notification, the financial institution then shifts the lifestages accordingly.

In block 112, the insurance coverage automatically shifts in accordance with the allocation choices. This shifting of the insurance coverage includes shifting the percentages of the insurance allocation, changing the insurance coverage products, and/or any combination thereof as predefined by the customer. For example, as illustrated in FIG. 2, the insurance coverage shifts from the first pie chart 202 to the second pie chart 204 and thus, the percentages change for each of the insurance coverage products 212, 214. After shifting lifestages, the method 100 proceeds back to block 110 to determine if any other lifestage shifts occur.

In block 114, a determination is made as to whether coverage of the lifestage insurance product is completed. If the lifestage insurance has been completed as agreed to by the customer and financial institution prior to enrolling the customer in the lifestage insurance product, then the lifestage insurance product is terminated in block 116. If the lifestage insurance coverage is still active, then the method proceeds to block 118.

In block 118, lifestage insurance is continued per the current lifestage and the insurance allocation assigned to the current lifestage. The method 100 then proceeds back to block 110 to continuously monitor whether another lifestage shift occurs.

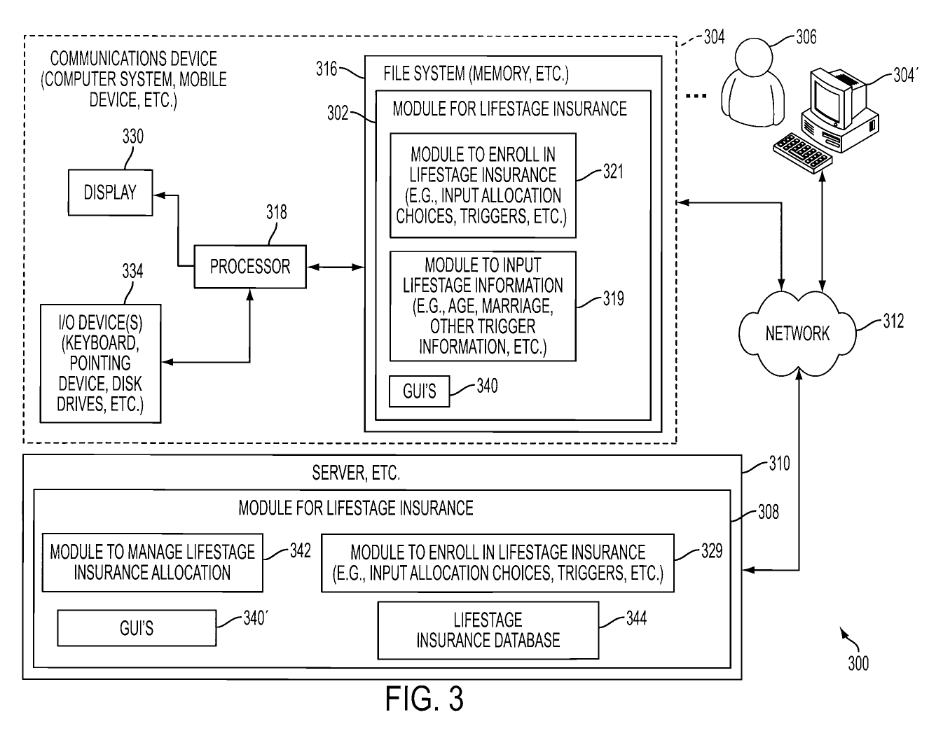

In one embodiment, the lifestage insurance is an online product such that the customer enrolls online and one or more of the steps of the method 100 is executed by the online product. The components and operations of an embodiment of the online product are described below with regard to FIG. 3.

FIG. 3 is a block schematic diagram of an example of a system 300 for lifestage insurance in accordance with an embodiment of the present invention. The system 300 includes a module for lifestage insurance 302 operable on a computer system 304 or similar device of a user 306 or a client. In addition to the module for lifestage insurance 302 on the user's computer system 304 or client, the system 300 includes a module for lifestage insurance 308 operable on a server 310 and accessible by the user 306 or client 304 via a network 312. The method 100 is embodied or performed by the module for lifestage insurance 302 or the server module for lifestage insurance 308. For example, the method 100 may be performed by the module for lifestage insurance 302. In another embodiment of the invention, the method 100 is performed by the server module for lifestage insurance 308. In a further embodiment of the present invention, some of the features or functions of the method 100 is performed by the module for lifestage insurance 302 on the user's computer system 304 and other features or functions of the method 100 is performed on the server module for lifestage insurance 308.

The network 312 is the Internet, a private network or other network as previously mentioned. Each computer system 304′ is similar to the exemplary computer system 304 and associated components as illustrated in FIG. 3.

The module for lifestage insurance 302 and/or 308 is a self contained system with imbedded logic, decision making, state based operations and other functions that operate lifestage insurance product.

The module for lifestage insurance 302 is stored on a file system 316 or memory of a computer system 304. The module for lifestage insurance 302 may be accessed from the file system 316 and run on a processor 318 associated with the computer system 304.

The module for lifestage insurance 302 includes a module to enroll in lifestage insurance 321. The module to enroll in lifestage insurance 321 allows entry of the various allocation choices such as the triggers, the lifestages, insurance coverages, insurance allocation percentages, and the like as previously described with respect to FIG. 1. The module to enroll in lifestage insurance 321 is accessed or activated whenever the user 306 desires to enroll in the lifestage insurance and calls other modules such as the graphical user interface 340, as described below. At this point, input of enrollment information is received by the module for lifestage insurance 308 on the server 310 via the network 312.

The module for lifestage insurance 302 also includes a module to input lifestage information 319. The lifestage insurance input module 319 allows entry of various triggers, such as age, marriage information, health, other lifestage event information, other trigger information, and the like. The lifestage insurance input module 319 is accessed or activated whenever the user 306 desires to input information, including trigger information or other information, and calls other modules such as the graphical user interface 340, as described below. The input of lifestage information is received by the module for lifestage insurance 308 on the server 310 via the network 312.

The user's computer system 304 includes a display 330. Any graphical user interfaces 340 associated with the module for lifestage insurance 308 is presented on the display 330. The user's computer system 304 also includes one or more input devices, output devices or combination input and output devices, collectively I/O devices 334. The I/O devices 334 may include a keyboard, computer pointing device, touch screen, touch pad, or similar devices to control input of information as described herein. The I/O devices 334 also include disk drives or devices for reading computer media including computer readable or computer operable instructions.

The module for lifestage insurance 302 presents the current status and other desired information of the lifestage insurance product to the user 306, such as by presenting the current status information to a display 330, storing the results in the file system 316, etc.

The server module for lifestage insurance 308 includes a module to enroll in lifestage insurance 329. The module to enroll in lifestage insurance 329 performs operations similar to the module to enroll in lifestage insurance 321 of the module for lifestage insurance 302 on the user's computer 304. However, the module to enroll in lifestage insurance 329 performs the operations on the server 310 and communicates with other modules on the server 310, such as the module to manage lifestage insurance 342.

The server module for lifestage insurance 308 includes a module to manage lifestage insurance 342. The module to manage lifestage insurance 342 performs functions such as shifting insurance allocation percentages upon shifting of lifestages, determining if the lifestages has shifted, reporting that a lifestage shift has occurred, reporting that the insurance coverages and/or insurance allocation has changed, receiving premiums, paying any required pay outs, terminating the lifestage insurance product, storing any information related to the lifestage insurance product, managing the online interface, retrieving/receiving information needed to manage the lifestage insurance, activating other modules in the server 310, or any other lifestage insurance or insurance allocation management.

The server module for lifestage insurance 308 also includes lifestage insurance database 344. The lifestage insurance database 344 includes any stored information related to the enrollment information and insurance allocation choices, such as information associated with each customer, each customer's allocation choices, each customer's current lifestage, received payment information, pay out information, triggers, insurance allocation, insurance coverages, and any other information associated with each customer with regard to the lifestage insurance product.

The module for lifestage insurance 302, 308 includes graphical user interfaces 340, 340′, as previously mentioned. The module for lifestage insurance 302, 308 allows one or more predetermined graphical user interfaces 340 to be presented to the user 306 in order for the user 306 to input data or information into the system 300. The graphical user interfaces 340 are predetermined and/or presented in response to the user 306 indicating the user 306 would like to perform a task associated with the lifestage insurance, such as setting up insurance allocation choices, inputting lifestage trigger information, receive status updates, input online banking logon information, receiving premiums, transferring payouts, allowing other inputs, presenting information to the customer and financial institution, etc. The predetermined graphical user interfaces 340 are generated by the module for lifestage insurance 302, 308 and are presented on the display 330 at the computer system 304. Graphical user interfaces 340 also include graphical user interfaces that permit the user 306 to view the lifestage insurance status and query any of the databases and/or generate reports and/or standardize documents.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, functions repeated by the two blocks shown in succession may, in fact, be executed substantially concurrently, or the functions noted in the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention, unless the context clearly indicates otherwise. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for a lifestage insurance product for a customer, comprising:
receiving at a computer system insurance allocation choices, the insurance allocation choices comprising:
a selection of a plurality of lifestages;
a selection of a plurality of insurance coverages for each of the plurality of lifestages;
an insurance allocation of the insurance coverages assigned for each of the plurality of lifestages;
providing insurance coverage of one of the lifestages in accordance with the insurance allocation choices;
determining a shift in lifestages has occurred; and
automatically shifting from the insurance allocation of insurance coverages for one of the plurality of lifestages to the insurance allocation of another one of the lifestages in response to the determining a shift in lifestages has occurred.

2. The method of claim 1, wherein the allocation choices further comprise selecting at least one predefined trigger which determines a shift in one of the lifestages to another one of the lifestages.

3. The method of claim 2, wherein the determining a shift in lifestages has occurred comprises receiving the at least one predefined trigger which determines a shift in lifestages.

4. The method of claim 3, wherein the at least one predefined trigger is based upon at least one of the customer's age, the customer getting married, the customer getting divorced, a death in the customer's family, and a birth of a customer's child.

5. The method of claim 1, wherein the determining a shift in lifestages has occurred comprises determining the age of the customer and determining if a shift in lifestages has occurred based on the customer's age.

6. The method of claim 1, wherein the assigning the insurance allocation for each of the plurality of lifestages comprises assigning percentages of a plurality of insurance coverages for each of the lifestages.

7. The method of claim 1, wherein receiving insurance allocation choices comprises:
a selection of a first insurance allocation comprising a first set of percentages of a first plurality of insurance coverages for the first lifestage; and
a selection of a second insurance allocation comprising a second set of percentages of a second plurality of insurance coverages for the second lifestage of the customer; and
wherein the shifting from the insurance allocation of insurance coverages for one of the plurality of lifestages to the insurance allocation of another one of the lifestages comprises shifting from the first insurance allocation to the second insurance allocation.

8. The method of claim 1, wherein the insurance allocation choices are received from the customer.

9. The method of claim 1, wherein the insurance coverages comprise insurance protection in a plurality of insurance protection areas.

10. The method of claim 1, wherein the insurance protection areas comprise at least one of long term disability, long term care, and personal health insurance.

11. The method of claim 1, further comprising receiving a premium from the customer based on the insurance allocation of the insurance allocation of a current lifestage.

12. The method of claim 1, further comprising paying the customer an insurance payout based upon the insurance allocation of a current lifestage.

13. A method for a lifestage insurance product for a customer, comprising:
receiving an insurance allocation for each of a plurality of lifestages, the plurality of lifestages comprising a first lifestage and a second lifestage;
providing insurance coverage of a first lifestage in accordance with the insurance allocation of the first lifestage; and
shifting the insurance coverage from the insurance allocation for the first lifestage to the insurance allocation for the second lifestage upon determining a shift in lifestages has occurred.

14. The method of claim 13, wherein the shifting from the insurance allocation for one of the plurality of lifestages to the insurance allocation for another one of the lifestages occurs in response to the determining a shift in lifestages has occurred.

15. A computer program product for a lifestage insurance product for a customer, the computer program product including a computer-readable medium having a computer program residing thereon, the computer program comprising:
instructions for receiving an insurance allocation for each of a plurality of lifestages, the plurality of lifestages comprising a first lifestage and a second lifestage;
instructions for providing insurance coverage of a first lifestage in accordance with the insurance allocation of the first lifestage; and
instructions for shifting the insurance coverage from the insurance allocation for the first lifestage to the insurance allocation for the second lifestage upon determining a shift in lifestages has occurred.

16. The computer program product of claim 15, the computer program further comprising:
instructions to provide insurance coverage of one of the lifestages in accordance with the insurance allocation for each of the lifestages; and
instructions to determine if a shift in lifestages has occurred.

17. The computer program product of claim 15, wherein instructions for receiving an insurance allocation for each of a plurality of lifestages comprises:
instructions for receiving a selection of the plurality of lifestages;
instructions for receiving a selection of the plurality of insurance coverages for each of the plurality of lifestages; and
instructions for receiving a selection of the insurance allocation of the insurance coverages assigned for each of the plurality of lifestages.

18. The computer program product of claim 17, wherein the insurance allocation further comprises a selection of at least one predefined trigger which determines a shift in one of the lifestages to another one of the lifestages.

19. The computer program product of claim 18, wherein the at least one predefined trigger is based upon at least one of the customer's age, the customer getting married, the customer getting divorced, a death in the customer's family, and a birth of a customer's child.

20. An apparatus for a lifestage insurance product for a customer, comprising:
a processor; and
a module operable on the processor, wherein the module is configured to:
receive an insurance allocation for each of a plurality of lifestages, the plurality of lifestages comprising a first lifestage and a second lifestage;
provide insurance coverage of a first lifestage in accordance with the insurance allocation of the first lifestage; and
shift the insurance coverage from the insurance allocation for the first lifestage to the insurance allocation for the second lifestage upon determining a shift in lifestages has occurred.

21. The apparatus of claim 20, wherein the module is further configured to:
provide insurance coverage of one of the lifestages in accordance with the insurance allocation for each of the lifestages; and
determine if a shift in lifestages has occurred.

22. The apparatus of claim 20, wherein the module is further configured to receive insurance allocation choices comprising:
a selection of the plurality of lifestages;
a selection of the plurality of insurance coverages for each of the plurality of lifestages; and
a selection of the insurance allocation of the insurance coverages assigned for each of the plurality of lifestages.

23. The apparatus of claim 22, wherein the insurance allocation further comprises a selection of at least one predefined trigger which determines a shift in one of the lifestages to another one of the lifestages.

24. The apparatus of claim 23, wherein the at least one predefined trigger is based upon at least one of the customer's age, the customer getting married, the customer getting divorced, a death in the customer's family, and a birth of a customer's child.
